(19) United States
(12) Patent Application Publication
(10) Pub. No.: US 2025/0041872 A1
(43) Pub. Date: Feb. 6, 2025

(54) APPARATUS AND METHOD FOR CRUSHING LUMPY MATERIAL

(71) Applicant: MOVIATOR OY, Vaajakoski (FI)

(72) Inventor: Pertti HÄNNINEN, Vaajakoski (FI)

(73) Assignee: MOVIATOR OY, Vaajakoski (FI)

(21) Appl. No.: 18/688,107

(22) PCT Filed: Aug. 31, 2022
(86) PCT No.: PCT/FI2022/050562

§ 371 Date: Feb. 29, 2024

(30) Foreign Application Priority Data
Aug. 31, 2021 (FI) 20210052

(51) Int. Cl. B02C 7/12; B02C 7/08

(52) U.S. Cl. CPC B02C 7/12; B02C 7/08

(57) ABSTRACT

An apparatus for crushing material includes an upper rotor and a lower rotor, the rotors rotating in a horizontal plane in opposite directions around a vertical axis of rotation, whereby in the center of the upper rotor there is an opening for feeding material between the upper rotor and the lower rotor, and pins on the outer rim of the upper rotor, whereby the lower rotor comprises pins and a central cone with blades, and that the pins of the lower rotor are mechanically fastened in a detachable manner to the lower rotor for individually replacing the pins and that the pins are installed in series in the radial direction of the lower rotor and all the pins of the lower rotor are closer to the axis of rotation of the rotors than the pins of the upper rotor.

The object of the present invention is an apparatus presented in the preamble of claim 1 and a method as specified in claim 13 for grinding lumpy material.

The apparatus and method according to the invention are well suited e.g. for crushing the slag produced in conjunction with steel slag or other metal manufacturing. Crushing slag is necessary for separating metal and slag materials from each other.

One apparatus to be implemented with the solution according to the invention is a mill, which is formed from two contra-rotating rotors; an upper rotor and a lower rotor. The material to be crushed is fed into the apparatus from the center of the upper rotor.

Grinder devices known per se in the art, or more concisely mills, applicable to grinding steel slag are disclosed e.g. in specification RU2611793. The mill according to the specification comprises an upper rotor and a lower rotor, which rotate in opposite directions. Grinding occurs between the pins fastened to the upper rotor and lower rotor. Material is fed in from the center of the mill from a channel between the top part of the mill and the lower rotor. The rotational speed of the mill is fairly low and the apparatus according to the specification is fairly sensitive to the size of the particles of material to be ground. If the particle size becomes excessive and the hardness of the particles is too hard, the apparatus becomes completely clogged and must be stopped for cleaning. The device according to the specification is suited for grinding material according to the particle size defined by the gap between the pins of the apparatus that are intended for grinding. Material of a larger particle size cannot be ground with it because such material clogs the device. Also variations in the hardness of material might clog the device.

All apparatuses known per se in the art have one or two rotors and are provided with crushing means. The apparatuses according to according to prior art do not, however, produce sufficient impact speed, i.e. crushing speed, so that they they could be used for crushing the aforementioned materials. The apparatuses are intended for softer materials and work only for certain-sized particles that have a clear maximum size determined by the gap between the crushing means.

The solution according to the invention operates at considerably greater speeds of rotation than the solutions according to the prior art solutions presented above. Furthermore, the according solution to specification RU2611793 is intended for grinding, whereas the solution according to the invention is intended for crushing. The grinding takes place between the pins and is based on the magnitude of the gap between the pins compared to the particle size of the material, whereas in the solution according to the invention the crushing of the particles takes place in the collision of the particles with the pins.

The purpose of this invention is to eliminate the drawbacks of prior art and to provide an apparatus and a method for crushing material, which apparatus and method enable different particle sizes and different particle hardnesses in the material to be crushed without any changes to be made in the apparatus, such as adjustment of distances between the pins or the like.

The solution according to the invention comprises an upper rotor rotatable in the horizontal plane around a vertical axis of rotation, the material to be crushed being fed through the center part of the rotor, and a lower rotor rotating the opposite direction around the same rotational axis, the material to be crushed between the rotors being fed from the center part of the upper rotor through an opening therein. The lower rotor comprises a central cone on which are blades for pre-crushing material. The central cone also improves the flow of infed material and air through the apparatus. In addition, two or more pins fastened in series in the direction of the rotation axis are fastened to the lower rotor in the direction of the radius of the lower rotor, said pins being attached to each other. The pins are replaceable and have a softer core giving flexibility and a sleeve providing a hard wear-resistant surface on the core. The attitude of the pins can also be changed by rotating, in which case they can be made to wear evenly and the service life of the crusher can be increased without major maintenance measures. The replaceability of the pins makes it possible to replace a single damaged pin quickly and easily without needing to detach and replace the entire lower rotor. Fastened to the upper rotor on its outer rim are also pins that collide with the material to be crushed after the pins of the lower rotor.

The pins fastened in series to the lower rotor improve the crushing of the material because, due to the high acceleration of the material, the material is subjected to a bouncing motion at the point of the pins fastened in series as the material exits towards the rim beyond the pins, thus often hitting them. When leaving the point of the pins of the lower rotor, the material still collides with the pins fastened to the upper rotor moving in the opposite direction.

One great advantage of the solution according to the a simple, operationally reliable and invention is inexpensive crusher device e.g. for crushing steel slag and for improving the quality of the crushing result.

The apparatus according to the invention is characterized by what is disclosed in the characterization part of claim 1. Correspondingly, the method according to the invention is characterized by what is disclosed in the characterization part of claim 13. Other embodiments of the invention are characterized by what is disclosed in the other claims.

In the following, the invention will be described in more detail by the aid of some preferred embodiments with reference to the simplified and diagrammatic drawings attached, wherein

FIG. 1 presents a simplified and sectioned side view of one apparatus according to the invention,

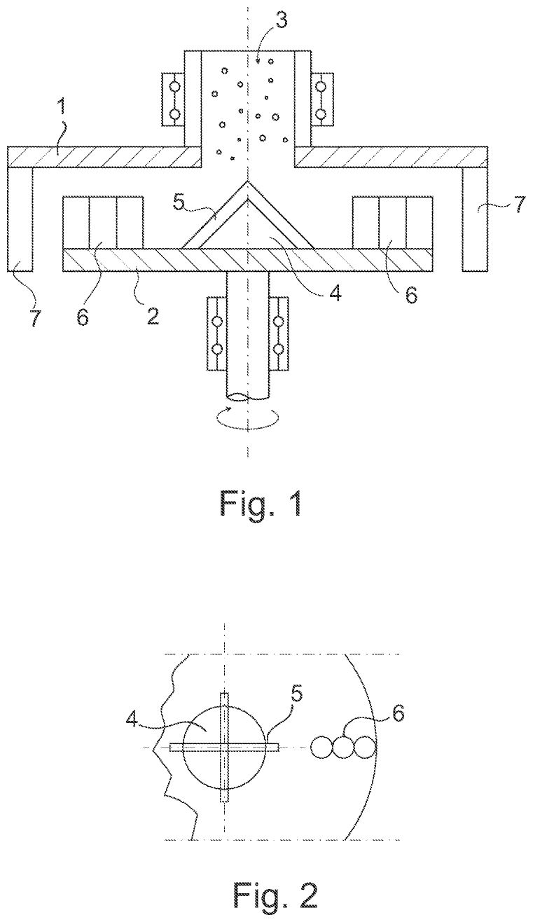

FIG. 2 presents a simplified top view of a part of the lower rotor of the apparatus according to FIG. 1,

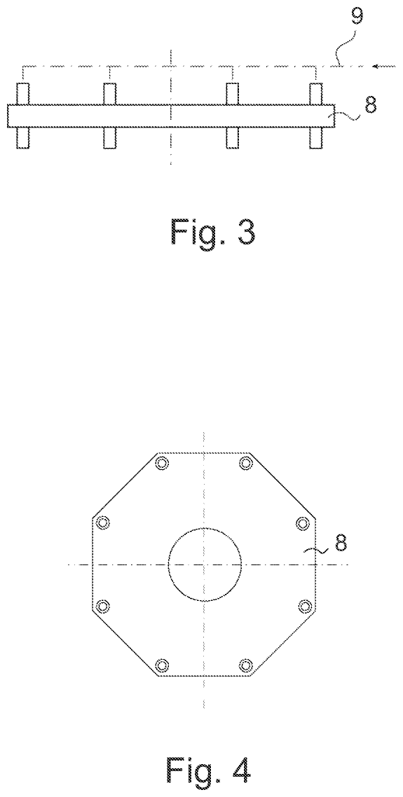

FIG. 3 presents a simplified side view of the cover part of the apparatus, and

FIG. 4 presents a simplified top view of the cover part of the apparatus.

FIG. 1 presents a simplified and sectioned side view of a preferred embodiment of an apparatus according to the invention. The apparatus comprises an upper rotor 1 and a lower rotor 2, the rotors rotating in opposite directions. Both rotors 1 and 2 rotate around the same axis of rotation. The diameter of the lower rotor 2 is typically approx. 900 mm and the diameter of the upper rotor is typically approx. 1300 mm. The material 3 is fed between the upper rotor and the lower rotor 2 from the center of the upper rotor 1. In the lower rotor 2 is a central cone 4 with blades 5. The central cone 4 functions as a pre-crusher and improves the flow of infed material 3 and air through the apparatus.

The lower rotor 2 comprises in this embodiment two or more series of round pins 6 in the direction of the axis of rotation. Each series comprises two or more pins 6. The pins 6 are mechanically fastened to the lower rotor and are easily detachable and individually replaceable. The pins 6 are also mechanically rotatable around their axes for evenly distributing their wear and for increasing the service life of the apparatus before necessary servicing. The inner edge and front edge in particular of the pins 6 wear more. The inner part of the pins 6 is made of a tougher steel, which is very resistant to impact stress without breaking, in which case the outer surface of the pins has a sleeve-like hard surface, which is very wear-resistant steel. The sleeve-like outer surface of the pins 6 can be replaced when it wears from crushing the material. The shape of the pins is not limited to pins of a round cross-section, but instead the pins may also be of polygonal cross-sectional shape, such as e.g. with 6, 8 or 10 corners.

The pins 6 are placed one beside another in a row/line in the direction of the radius of the lower rotor 2. The pins are preferably placed in contact with each other, but they can also be placed at a small distance from each other to facilitate the replacement and rotation of the pins. The distance between the pins 6 is then less than 20 mm, preferably less than 15 mm, and very advantageously less than 10 mm. In the embodiment according to FIG. 1, there are three pins 6 and they are placed in contact with each other. The number of pins 6 can, however, vary between two and eight. Preferably there are 3-6 units of pins 6 and very advantageously 3-5 units in each series. The number of series of pins 6 on the lower rotor 2 is an even number such that two series are always placed each on the opposite side of the bottom rotor with respect to one another. There can also be an odd number of series of pins 6, in which case they are located at regular intervals on the lower rotor 2. In this way the lower rotor 2 is made to remain balanced. There are 2-8, preferably 2-6 and very advantageously 3-4 series on the lower rotor.

Since the lower rotor 2 rotates at a considerably high speed, the material 3 moved by the centrifugal force is subjected to a bouncing movement past the row/line formed by the pins 6, towards the outer rim of the lower rotor as it moves. In this case, the crushing force brought about by the pins 6 is considerable and, due to the bouncing movement, the crushing force is exerted on the same material particle many times.

The so-called crushing means of the lower rotor 2 is thus formed from 2-8 pins 6 with hard sleeves installed one after another in the radial direction of the lower rotor. Preferably such a series of pins 6 is placed to start inwards from the outer rim of the lower rotor 2 as shown in FIG. 1. However, the series can be located in such a way that there is a distance between the surface of the outermost pin 6 and the outer edge of the lower rotor 2, the distance corresponding to the thickness of 1-2 pins.

Due to the centrifugal force and the movement produced by the crushing means of the lower rotor 2, the material 3 when exiting further hits the pin/pins 7 of the upper rotor 1 rotating in the opposite direction. On the upper rotor 1 there is an even number of pins 7 in such a way that the units in a pair are always located on opposite sides of the upper rotor. There may also be an odd number of pins 7, in which case they are placed at regular intervals on the upper rotor 1. With this kind of placement the upper rotor 1 is made to stay in balance. There are 4-16 units of these pins 7 on the upper rotor 1, preferably 4-12, and very advantageously 4-8 units. All the pins 6 of the lower rotor 2 are positioned closer to the rotating axis of the rotors than any of the pins 7 of the upper rotor 1. This means that the use of the apparatus is not critical to the size of the material particles as is the case with prior art apparatuses where every other pin is moving to the opposite direction and the gap between the opposite direction rotating pins determines the maximum particle size of the apparatus. The high velocity difference between the two rotors (upper and lower) is creating high crushing force to the material particles and the uneven surface created by the row of pins 6 in the lower rotor 2 scatter the material particles to all directions from the pins enhancing the crushing effect. The apparatus according to the invention enables the use of higher rotation speeds than the prior art apparatuses equipped with pins.

FIG. 2 presents a simplified top view of a part of the lower rotor 2 of the apparatus according to FIG. 1. The central cone 4 with its blades 5 performs pre-crushing of the material and distributes the material inside between the upper rotor and the lower rotor. A row/line of pins 6 is placed in the radial direction of the lower rotor from the outer edge of the lower rotor towards the axis of rotation of the lower rotor. The pins 6 are located in this embodiment attached to each other and there are three units of them.

FIG. 3 presents a simplified schematic drawing of the cover 8 of the apparatus as viewed from the side. The top part of the apparatus is providable at regular intervals with pneumatic impacts via the cover 8 from above and/or from the side and through the piping 9 for the purpose of cleaning the inner part of the apparatus. Such a need for cleaning can especially occur with materials that are extremely difficult crush. Especially moist materials that adhere to the walls are such that they produce a need for cleaning of the apparatus. Via the piping 9, it is also possible to introduce water or some other substance into the apparatus for preventing dusting as well as various chemicals used in conjunction with crushing.

FIG. 4 presents a simplified illustration of an embodiment of the cover 9 of the apparatus as viewed from above. In this embodiment, the cover 9 is octagonal, but its shape is not limited to the shape shown in FIG. 4; instead the cover can also be e.g. circular or some other polygonal shape.

In the method according to the invention, material 3 is fed through an opening in the center of the upper rotor into the space between the upper rotor and the lower rotor. The material 3 is pre-crushed in the central cone 4 in the center of the lower rotor, on which cone there are blades 5 for intensifying the crushing. The lower rotor 2 is further provided with two or more rows/lines of pins 6, which rows/lines are arranged in the radial direction of the lower rotor close to the outer rim of the lower rotor. The row/line of pins 6 forms a so-called crushing means, of which crushing means there is an even number on the lower rotor 2 in such a way that the units of the pair are always on opposite sides of the lower rotor in order to maintain the balance of the lower rotor. There can also be an odd number of the crushing means formed by the pins 6, in which case they are located at regular intervals on the lower rotor 2 in order to maintain the balance. The number of round pins 6 in each row/line can be 2-8 units. The shape of the pins 6 can also be other than circular in cross-section, e.g. a polygonal cross-section, such as a hexagonal, octagonal or decagonal cross-section, is possible. The pins 6 are mechanically fastened to the lower rotor 2 and they are replaceable individually and, if necessary, can be turned to control the smooth wear of the pins. Due to the centrifugal force generated by the rotational movement of the lower rotor 2, the material 3 to be crushed proceeds from the center of the lower rotor towards the outer edge of the lower rotor, colliding on the way with a row/line formed by the pins 6. The fast rotational movement of the lower rotor 2 causes the material 3 to bounce on the surface of the crushing means formed by the pins 6, whereby the crushing of the material becomes more efficient. As the material 3 exits from the top of the lower rotor 2, the material still collides with the pin/pins 7 of the upper rotor 1 rotating in the opposite direction. The pins 7 on the upper rotor 1 are on one rim of the upper rotor. The number of the pins 7 can vary between 4-16, and for balance there is preferably an even number of them in such a way that the pins of a pair are on opposite sides of the upper rotor 1. There may also be an odd number of pins 7, in which case they are placed at regular intervals on the upper rotor 1.

The rotational speed of the upper rotor is 1100-700 rpm, preferably 1050-750 rpm and very advantageously 1000-800 rpm. Correspondingly, the rotational speed of the lower rotor is 1200-800 rpm, preferably 1150-850 rpm and very advantageously 1100-900 rpm. In the prior art devices intended mainly for grinding material, the rotational speeds are in the order of 600-700 rpm, when only the lower rotor is rotating. When both rotors rotate, their speeds are in the order of 500 rpm for the upper rotor and for the lower rotor. However, such solutions according to prior art are not solutions based on crushing, but instead on the grinding of the material to be smaller based on the magnitude of the gap between the pins. Such prior art apparatuses are not suitable for crushing the slag produced in conjunction with steel slag or other metal manufacture, but instead they are intended for grinding softer fibrous material.

The method can also comprise the phases of supplying water or other liquid to the material 3 to be crushed and/or of producing pneumatic impacts via the piping 9 of the cover 8 of the apparatus into the inner parts of the apparatus from above and/or from the side of the apparatus.

It is obvious to the person skilled in the art that the invention is not limited solely to the examples described above, but that it may be varied within the scope of the claims presented below. Thus, for example, the apparatus can differ in its structural solutions to what is presented above.

1. An apparatus for crushing material, the apparatus comprising an upper rotor and a lower rotor, the rotors rotating in a horizontal plane in opposite directions around a vertical axis of rotation, whereby in the center of the upper rotor there is an opening for feeding material between the upper rotor and the lower rotor, and pins on the outer rim of the upper rotor, whereby the lower rotor comprises pins and a central cone with blades, wherein the pins of the lower rotor are mechanically fastened in a detachable manner to the lower rotor for individually replacing the pins, and in that the pins are installed in series in the radial direction of the lower rotor and all the pins of the lower rotor are closer to the axis of rotation of the rotors than the pins of the upper rotor.

2. Apparatus according to claim 1, wherein the pins are round or polygonal in cross-sectional shape and of tough steel in their interior and on the surface of them is a sleeve made of hard steel, and in that they are turnable for evenly distributing their wear.

3. Apparatus according to claim 1, wherein there are 2-8 units, preferably 3-6 units, and very advantageously 3-5 units, of pins in a series of pins.

4. Apparatus according to claim 1, wherein the series of pins are located at regular intervals on the lower rotor, in which case the lower rotor is in balance, and in that there are 2-8, preferably 2-6, and very advantageously 3-4, series on the lower rotor.

5. Apparatus according to claim 1, wherein the pins of a series on the lower rotor are located attached to each other.

6. Apparatus according to claim 5, wherein the pins of a series on the lower rotor are located at a distance from each other, in which case the distance between the pins is less than 20 mm, preferably less than 15 mm, and very advantageously less than 10 mm.

7. Apparatus according to claim 1, wherein a series of pins on the lower rotor is located to start from the outer rim of the lower rotor towards the axis of rotation of the lower rotor.

8. Apparatus according to claim 1, wherein between the surface of the outermost pin on the lower rotor and the outer edge of the lower rotor is a distance that corresponds to the thickness of 1-2 pins from the outer rim of the lower rotor towards the axis of rotation of the lower rotor.

9. Apparatus according to claim 1, wherein the rotational speed of the lower rotor is 1200-800 rpm, preferably 1150-850 rpm, and very advantageously 1100-900 rpm.

10. Apparatus according to claim 1, wherein the rotational speed of the upper rotor is 1100-700 rpm, preferably 1050-750 rpm, and very advantageously 1000-800 rpm.

11. Apparatus according to claim 1, wherein the pins of the upper rotor are on one rim and in that there are 4-16 of them, and in that they are placed at regular intervals on the upper rotor.

12. Apparatus according to claim 1, wherein the apparatus comprises a cover provided with piping, through which piping pneumatic impacts and/or water and/or other liquid or chemicals can be supplied from the top and/or from the side of the apparatus.

13. Method for crushing lumpy material, the method comprising an upper rotor rotatable in a horizontal plane around a vertical axis of rotation, and a lower rotor rotatable in the opposite direction around the same axis of rotation, between which rotors material is fed from an opening in the center of the upper rotor onto the central cone of the lower rotor, whereby the blades of the central cone pre-crush the material, wherein the pins fastened to the lower rotor form a series, which series causes the material to move in a bouncing manner in front of the pins, and in that when leaving from the top of the lower rotor the material collides with the pins of the upper rotor, and in that all the pins of the lower rotor are closer to the axis of rotation of the rotors than the pins of the upper rotor.

14. Method according to claim 13, wherein the apparatus is given pneumatic impacts at regular intervals through the piping of the cover from above and/or from the side of the apparatus.

15. Method according to claim 13, wherein water or other liquid and/or chemicals are added to the apparatus via the piping of the cover.

16. Method according to claim 13, wherein the rotational speed of the lower rotor is 1200-800 rpm, preferably 1150-850 rpm, and very advantageously 1100-900 rpm.

17. Method according to claim 13, wherein the rotational speed of the upper rotor is 1100-700 rpm, preferably 1050-750 rpm, and very advantageously 1000-800 rpm.
